(19) United States
(12) Patent Application Publication
(10) Pub. No.: US 2009/0291362 A1
(43) Pub. Date: Nov. 26, 2009

(54) Flat-type alkaline primary battery

(76) Inventor: Norishige Yamaguchi, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/454,576

(22) Filed: May 19, 2009

(30) Foreign Application Priority Data
May 21, 2008 (JP) 2008-133309

(51) Int. Cl. H01M 6/46

(52) U.S. Cl. 429/162

(57) ABSTRACT

A flat-type alkaline primary battery has a positive electrode mixture containing a positive electrode active material, a negative electrode mixture containing a negative electrode active material, and a separator for separating the positive electrode mixture and the negative electrode mixture. An alkaline electrolyte solution is contained in the positive electrode mixture, the negative electrode mixture, and the separator. The negative electrode active material includes zinc or zinc alloy powder. The positive electrode active material includes nickel oxyhydroxide containing cobalt in solid solution, the surface of which is coated with a conductive material.

### BACKGROUND OF THE INVENTION

1. Field of the Invention

The present invention relates to flat-type alkaline primary batteries.

2. Description of Related Art

A flat-type alkaline primary battery of a coin-type, a button-type, or the like, that is used for small-size electronic apparatus such as an electronic wrist watch and a portable electronic calculator is equipped with a positive electrode can accommodating a positive electrode mixture and a negative electrode can accommodating a negative electrode mixture. The positive electrode mixture and the negative electrode mixture are opposed across a separator. The positive electrode mixture, the negative electrode mixture, and the separator are impregnated with an electrolyte solution.

Examples of the flat-type alkaline primary batteries of this type that have been widely on the market are an alkaline manganese battery, which employs manganese dioxide as the positive electrode active material, and a silver oxide battery, which employs silver oxide as the positive electrode active material. The silver oxide battery has an advantage of high volumetric energy density. Also, it shows a flat battery voltage in the vicinity of 1.56 V with the negative electrode active material of zinc. For this reason, the silver oxide battery is used mainly as a power source for small-size electronic apparatus, such as an electronic wristwatch and portable electronic calculator, that has an end voltage of 1.2 V or higher.

However, silver oxide is expensive because it contains silver, which is a noble metal, as the main component, although it is favorable in terms of performance. The price of silver oxide fluctuates depending on the silver market price, so silver oxide is a substance that is difficult to use when lower and stable manufacturing cost is desired.

In contrast, the cost of the alkaline manganese battery per mass is about 1/200 of the silver oxide battery, so a large number of alkaline manganese batteries are on the market. However, the alkaline manganese battery has a lower volumetric energy density than the silver oxide battery, so the voltage significantly drops as the discharge progresses. For this reason, the alkaline manganese battery causes the problem that the operating time of the apparatus becomes short because of the voltage drop originating from the discharge of manganese dioxide, in the apparatus in which the end voltage is set to be relatively high according to the battery voltage of the silver oxide battery, such as an electronic wristwatch. Various studies have been made to prevent the voltage drop, but they have not been sufficient.

As a means for resolving the problem, a battery containing nickel oxyhydroxide as the positive electrode active material has been proposed (for example, JP-A-2003-234107, JP-A-2004-6092, and JP-A-2005-19349). The flat-type alkaline primary battery employing nickel oxyhydroxide as the positive electrode active material has the advantage of relatively high battery voltage.

Nevertheless, in the case of the battery employing nickel oxyhydroxide as the positive electrode active material, the theoretical electrical capacity of nickel oxyhydroxide per unit mass is 292 mAh/g, which is less than that of manganese dioxide, 308 mAh/g, (per valence of manganese), although the battery voltage is higher than that of the silver oxide battery. Therefore, with the use of nickel oxyhydroxide, it has been difficult to improve the capacity over the alkaline manganese battery.

In addition, the conductivity of nickel oxyhydroxide itself is low, and moreover, the nickel hydroxide formed by reducing nickel oxyhydroxide during the discharge reaction has almost no conductivity. Furthermore, nickel oxyhydroxide increases in volume as the electrolyte solution absorption and the discharge progress. From an experiment by the inventors, it has been found that, due to these factors, the proportion of the conductive agent in the positive electrode mixture becomes low, causing the problem of considerable degradation in the capacity and the capacity retention capability.

The invention has been accomplished in order to solve the foregoing problems. It is an object of the invention to provide a flat-type alkaline primary battery that is excellent in battery capacity and capacity retention capability.

### SUMMARY OF THE INVENTION

A flat-type alkaline primary battery according to the invention comprises: a positive electrode mixture containing a positive electrode active material comprising nickel oxyhydroxide in which cobalt is dissolved in the form of solid solution; a negative electrode mixture containing a negative electrode active material comprising zinc or zinc alloy powder; a separator for separating the positive electrode mixture and the negative electrode mixture; and an alkaline electrolyte solution, wherein a surface of the positive electrode active material is coated with a conductive material.

According to the invention, the surface of the nickel oxyhydroxide in which cobalt is dissolved in the form of solid solution is coated with a conductive material. Therefore, it is possible to prevent the degradation in the electrical conductivity resulting from the nickel hydroxide formed by the discharge reaction, which has low conductivity. Moreover, it is possible to prevent the degradation in electrical conductivity originating from the volumetric expansion due to the formation of nickel hydroxide and the volumetric expansion due to the electrolyte solution absorption. As a result, it is possible to improve the capacity and obtain a good battery excellent in capacity retention capability.

In the flat-type alkaline primary battery, the surface of the nickel oxyhydroxide is coated with one of γ cobalt oxyhydroxide, graphite, and a silver-nickel composite oxide.

This makes it possible to prevent the degradation in electrical conductivity because the surface of the nickel oxyhydroxide is coated with one of γ cobalt oxyhydroxide, graphite, and a silver-nickel composite oxide.

In this flat-type alkaline primary battery, the coating amount of the γ cobalt oxyhydroxide is from 1 mass % to 10 mass % with respect to the mass of the cobalt oxyhydroxide.

According to this, the coating amount of the γ cobalt oxyhydroxide is from 1 mass % to 10 mass % with respect to the mass of the nickel oxyhydroxide. Therefore, the degradation in electrical conductivity can be prevented efficiently with a small addition amount.

In this flat-type alkaline primary battery, the coating amount of the graphite is from 3 mass % to 10 mass % with respect to the mass of the nickel oxyhydroxide.

This makes it possible to prevent the degradation in electrical conductivity originating from the formation of nickel hydroxide by the discharge reaction, the absorption of the electrolyte solution, and the volumetric expansion. Thus, it becomes possible to obtain a battery that is excellent in the capacity and the capacity retention capability.

In this flat-type alkaline primary battery, the coating amount of the silver-nickel composite oxide is from 5 mass % to 20 mass % with respect to the nickel oxyhydroxide.

This makes it possible to prevent the degradation in electrical conductivity originating from the formation of nickel hydroxide by the discharge reaction, the absorption of the electrolyte solution, and the volumetric expansion. Thus, it becomes possible to obtain a battery that is excellent in the capacity and the capacity retention capability.

In this flat-type alkaline primary battery, the amount of solid solution of the cobalt in the nickel oxyhydroxide is from 1% to 10% with respect to the mass of the nickel oxyhydroxide.

This enables the nickel oxyhydroxide to exhibit a decomposition inhibiting effect because of the structure reinforcing effect of cobalt, and it becomes possible to obtain a battery that is excellent in the capacity retention capability.

The invention makes it possible to provide a flat-type alkaline primary battery that is excellent in the battery capacity and the capacity retention capability.

### BRIEF DESCRIPTION OF THE DRAWINGS

FIG. 1 is a cross-sectional view of a flat-type alkaline primary battery according to the invention.

FIG. 2 is a table showing the results of an experiment for examples and comparative examples of the invention.

### DETAILED DESCRIPTION OF THE INVENTION

Hereinbelow, one embodiment of the invention is described with reference to the drawings.

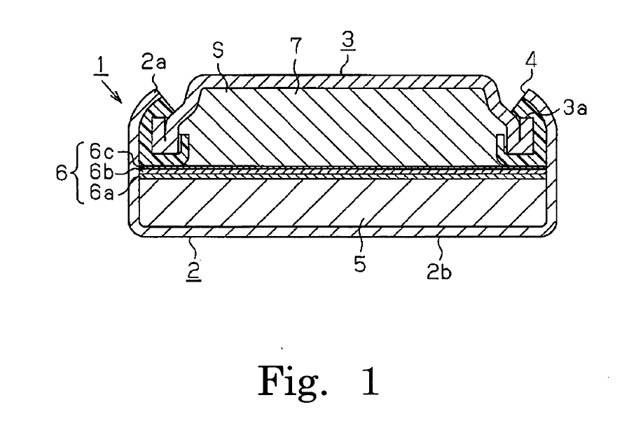

FIG. 1 shows a schematic cross-sectional view of a button-type (flat-type) alkaline primary battery. In FIG. 1, an alkaline primary battery 1 is a button-type primary battery, and it has a closed-bottom cylindrical positive electrode can 2 and a closed-top cylindrical negative electrode can 3. The positive electrode can 2 has a structure in which stainless steel (SUS) is plated with nickel, and it also serves as the positive electrode terminal. On the other hand, the negative electrode can 3 has a structure in which a three-layer clad material having an outer surface layer made of nickel, a metal layer made of stainless steel (SUS), and a current collector layer made of copper is pressed in a cup shape. A circular opening portion 3a is formed by folding over the negative electrode can 3. A ring-shaped gasket 4, which is made of nylon, for example, is fitted to the opening portion 3a, which is formed by folding over the negative electrode can 3.

Then, the negative electrode can 3 is fitted to a circular opening portion 2a of the positive electrode can 2 from the opening portion 3a side on which the gasket 4 is fitted, and the opening portion 2a of the positive electrode can 2 is clamped toward the gasket 4 to seal the opening. Thereby, the positive electrode can 2 and the negative electrode can 3 are joined and fixed to each other. By joining and fixing the positive electrode can 2 and the negative electrode can 3 to each other, a hermetically-closed space S is formed between the positive electrode can 2 and the negative electrode can 3 with the gasket 4 interposed therebetween.

In this hermetically closed space S, a positive electrode mixture 5, a separator 6, and a negative electrode mixture 7 are accommodated, and the positive electrode mixture 5 is accommodated and disposed on the positive electrode can 2 side across the separator 6, while the negative electrode mixture 7 is accommodated and disposed on the negative electrode can 3 side across the separator 6. The positive electrode mixture 5 is a bottom portion 2b of the positive electrode can 2.

In more detail, the positive electrode mixture 5 is prepared as follows. Nickel oxyhydroxide powder is prepared by coating a surface of nickel oxyhydroxide in which cobalt is dissolved in the form of solid solution with a conductive material having a low electrical resistance. The nickel oxyhydroxide powder, a conductive agent, a dry lubricant, a binder agent, and an alkaline electrolyte solution were mixed, and the mixture was formed in a cylindrical pellet form press-formed by a tablet press or the like.

One of γ cobalt oxyhydroxide, graphite, and a silver-nickel composite oxide may be used as the conductive material that is low in electrical resistance and suitable for coating the nickel oxyhydroxide. This makes it possible to prevent the degradation in electrical conductivity associated with the volumetric expansion of the positive electrode mixture 5. Specifically, although nickel oxyhydroxide is reduced to nickel hydroxide by the discharge reaction, nickel hydroxide is greater in volume than nickel oxyhydroxide, and therefore, the volume of the positive electrode mixture 5 expands as the discharge reaction progresses. In addition, nickel oxyhydroxide absorbs an alkaline electrolyte solution and swells. At this time, the volumetric expansion of nickel oxyhydroxide or nickel hydroxide can be inhibited by the coating layer of the conductive material formed on the surface of the nickel oxyhydroxide. As a result, the proportion of the conductive agent per unit volume in the positive electrode mixture does not reduce, and therefore, it is possible to prevent the degradation in electrical conductivity. Moreover, even when nickel hydroxide that has a low electrical conductivity is formed as the discharge reaction progresses, electrical conductivity in the positive electrode mixture is ensured by the conductive material coated on the nickel hydroxide. Therefore, a battery that is excellent in the capacity and the capacity retention capability can be obtained.

In addition, it is preferable that the amount of solid solution of cobalt in the nickel oxyhydroxide be from 1 mass % to 10 mass % with respect to the mass of the nickel oxyhydroxide.

If the amount of solid solution of cobalt in the nickel oxyhydroxide is lower than 1 mass %, the decomposition inhibiting effect of the nickel oxyhydroxide resulting from the structure reinforcing effect of cobalt becomes insufficient, degrading the capacity retention capability considerably. On the other hand, if the amount of solid solution of cobalt in the nickel oxyhydroxide is higher than 10 mass %, the electric capacity of the nickel oxyhydroxide reduces correspondingly.

The following methods may be used in the case of forming nickel oxyhydroxide on which γ cobalt oxyhydroxide is coated. For example, sulfuric acid cobalt and an aqueous solution of sodium hydroxide are added to nickel hydroxide to deposit α cobalt hydroxide and β cobalt hydroxide on the surface of the nickel hydroxide. The aqueous solution of sodium hydroxide is added further and the mixture is heated to thereby oxidize the cobalt hydroxide on the surface into γ cobalt oxyhydroxide. In addition, the nickel hydroxide inside is oxidized into β nickel oxyhydroxide by sodium hypochlorite. Alternatively, an aqueous solution of sodium hydroxide may be added to nickel hydroxide and cobalt hydroxide, then the mixture is heated to deposit γ cobalt oxyhydroxide on the surface of the nickel hydroxide, and the nickel hydroxide inside may be oxidized into β nickel oxyhydroxide by sodium hypochlorite.

It is preferable that the coating amount of the γ cobalt oxyhydroxide is from 1 mass % to 5 mass % with respect to the mass of the nickel oxyhydroxide. The reason is that if the mass ratio of the γ cobalt oxyhydroxide coated on the nickel oxyhydroxide is lower than the 1 mass %, the degradation in electrical conductivity, which results from the formation of nickel hydroxide originating from the discharge reaction, the absorption of the electrolyte solution, and the volumetric expansion associated with the discharge cannot be prevented sufficiently. Moreover, if the coating amount of the γ cobalt oxyhydroxide becomes higher than 5 mass % with respect to the mass of the nickel oxyhydroxide, the electric capacity of the nickel oxyhydroxide reduces correspondingly. As a result, the electrical capacity reduces.

In addition, in the case that graphite is coated on the nickel oxyhydroxide, it is preferable that the coating amount thereof be from 3 mass % to 10 mass % with respect to the mass of the nickel oxyhydroxide.

The reason is also that if the mass ratio of the graphite coated on the nickel oxyhydroxide is lower than the 3 mass %, the degradation in electrical conductivity, which results from the formation of nickel hydroxide originating from the discharge reaction, the absorption of the electrolyte solution, and the volumetric expansion associated with the discharge, cannot be prevented sufficiently. On the other hand, if the mass ratio of the graphite coated on the nickel oxyhydroxide is higher than 10 mass %, the electric capacity of the nickel oxyhydroxide reduces correspondingly.

In addition, in the case that silver-nickel composite oxide is coated on the nickel oxyhydroxide, it is preferable that the coating amount thereof be from 5 mass % to 20 mass % with respect to the mass of the nickel oxyhydroxide.

The reason is also that if the mass ratio of the silver-nickel composite oxide coated on the nickel oxyhydroxide is lower than the 5 mass %, the degradation in electrical conductivity, which results from the formation of nickel hydroxide originating from the discharge reaction, the absorption of the electrolyte solution, and the volumetric expansion associated with the discharge, cannot be prevented sufficiently. On the other hand, if the mass ratio of the silver-nickel composite oxide coated on the nickel oxyhydroxide is higher than 20 mass %, the addition amount of expensive silver, which is contained in the silver-nickel composite oxide, needs to be increased correspondingly, and accordingly, the manufacturing cost increases.

The negative electrode mixture 7 contains zinc or zinc alloy powder, a zinc oxide, a thickening agent such as carboxymethylcellulose, an alkaline electrolyte solution, and a zinc corrosion inhibitor. It is formed in a gel form.

Next, various examples in which the solid solution of nickel oxyhydroxide, the coating on nickel oxyhydroxide, the type of conductive agent, and the coating amount were varied were prepared to verify the advantageous effects of the invention.

### EXAMPLE 1

With the battery structure shown in FIG. 1, the negative electrode can 3 was formed by pressing a 0.15 mm-thick clad material having three layers, namely, a nickel outer surface layer, a stainless steel (SUS) metal layer, and a copper current collector layer. The positive electrode mixture 5 contained 80 mass % of nickel oxyhydroxide powder as a primary positive electrode active material, 15 mass % of a silver-nickel composite oxide as a secondary positive electrode active material, 1 mass % of fluorocarbon polymer powder as a dry lubricant, 2 mass % of resin powder as a binder agent, and 2 mass % of aqueous solution of potassium hydroxide at a concentration of 37% as an electrolyte solution. These substances were mixed by a blender and thereafter formed in a pellet form using a tablet press. The nickel oxyhydroxide, which was the primary positive electrode active material, contained 5 mass % of cobalt with respect to the mass of the nickel oxyhydroxide in the form of solid solution, and the surface thereof was coated with γ cobalt oxyhydroxide at a mass ratio of 3%.

Next, the positive electrode mixture 5 was inserted into the positive electrode can 2, and an alkaline electrolyte solution containing potassium hydroxide was filled therein to cause the positive electrode mixture 5 to absorb the alkaline electrolyte solution. The separator 6 with a three-layer structure of a microporous film 6a, a cellophane film 6b, and a nonwoven fabric 6c, which was punched out into a circular shape, was placed over the positive electrode mixture 5, and the alkaline electrolyte solution containing 37% potassium hydroxide aqueous solution was dropped thereon to impregnate the alkaline electrolyte solution therein. The negative electrode mixture 7 in a gel form was placed over the separator 6. The negative electrode mixture 7 contained: 61 mass % of zinc alloy powder; 2.68 mass % of zinc oxide; 1.475 mass % of a highly cross-linked sodium polyacrylate and 1.475 mass % of carboxymethylcellulose as active material stabilizing agents; and 33.36 mass % of 45% potassium hydroxide aqueous solution. Then, the negative electrode can 3 and the positive electrode can 2 were hermetically sealed by clamping them together with the gasket 4 interposed therebetween.

### EXAMPLE 2

Example 2 had the same configuration as that of Example 1, except that the amount of the cobalt dissolved in the nickel oxyhydroxide in the form of solid solution was set at 1 mass %.

### EXAMPLE 3

Example 3 had the same configuration as that of Example 1, except that the amount of the cobalt dissolved in the nickel oxyhydroxide in the form of solid solution was set at 10 mass %.

### EXAMPLE 4

Example 4 had the same configuration as that of Example 1, except that the mass ratio of the γ cobalt oxyhydroxide coated on the nickel oxyhydroxide was set at 1 mass %.

### EXAMPLE 5

Example 5 had the same configuration as that of Example 1, except that the mass ratio of the γ cobalt oxyhydroxide coated on the nickel oxyhydroxide was set at 5 mass %.

### EXAMPLE 6

Example 6 had the same configuration as that of Example 1, except that the conductive agent that was coated on the nickel oxyhydroxide was graphite, and the mass ratio thereof was set at 3%.

### EXAMPLE 7

Example 7 had the same configuration as that of Example 1, except that the conductive agent that was coated on the nickel oxyhydroxide was graphite, and the mass ratio thereof was set at 10%.

### EXAMPLE 8

Example 8 had the same configuration as that of Example 1, except that the conductive agent that was coated on the nickel oxyhydroxide was a silver-nickel composite oxide, and the mass ratio thereof was set at 5%.

### EXAMPLE 9

Example 9 had the same configuration as that of Example 1, except that the conductive agent that was coated on the nickel oxyhydroxide was a silver-nickel composite oxide, and the mass ratio thereof was set at 20%.

### COMPARATIVE EXAMPLE 1

Comparative Example 1 had the same configuration as that of Example 1, except that the solid solutions to be dissolved in the nickel oxyhydroxide were 3% of zinc and 5% of cobalt.

### COMPARATIVE EXAMPLE 2

Comparative Example 2 had the same configuration as that of Example 1, except that nickel oxyhydroxide on which no conductive material was coated was used.

### COMPARATIVE EXAMPLE 3

Comparative Example 3 had the same configuration as that of Example 1, except that the solid solution to be dissolved in the nickel oxyhydroxide was 0.5 mass % of cobalt.

### COMPARATIVE EXAMPLE 4

Comparative Example 4 had the same configuration as that of Comparative Example 1, except that the solid solution to be dissolved in the nickel oxyhydroxide was 12 mass % of cobalt.

### COMPARATIVE EXAMPLE 5

Comparative Example 5 had the same configuration as that of Example 1, except that the mass ratio of the γ cobalt oxyhydroxide that was coated on the nickel oxyhydroxide was set at 0.5 mass %.

### COMPARATIVE EXAMPLE 6

Comparative Example 6 had the same configuration as that of Example 1, except that the mass ratio of the γ cobalt oxyhydroxide that was coated on the nickel oxyhydroxide was set at 7 mass %.

### COMPARATIVE EXAMPLE 7

Comparative Example 7 had the same configuration as that of Comparative Example 1, except that the conductive agent that was coated on the nickel oxyhydroxide was graphite, and the mass ratio thereof was set at 1%.

### COMPARATIVE EXAMPLE 8

Comparative Example 8 had the same configuration as that of Comparative Example 1, except that the conductive agent that was coated on the nickel oxyhydroxide was graphite, and the mass ratio thereof was set at 12%.

### COMPARATIVE EXAMPLE 9

Comparative Example 9 had the same configuration as that of Comparative Example 1, except that the conductive agent that was coated on the nickel oxyhydroxide was a silver-nickel composite oxide, and the mass ratio thereof was set at 3%.

Then, 40 samples of each of the alkaline batteries of Examples 1 through 9 and Comparative Examples 1 through 9 were prepared to carry out the following examinations.

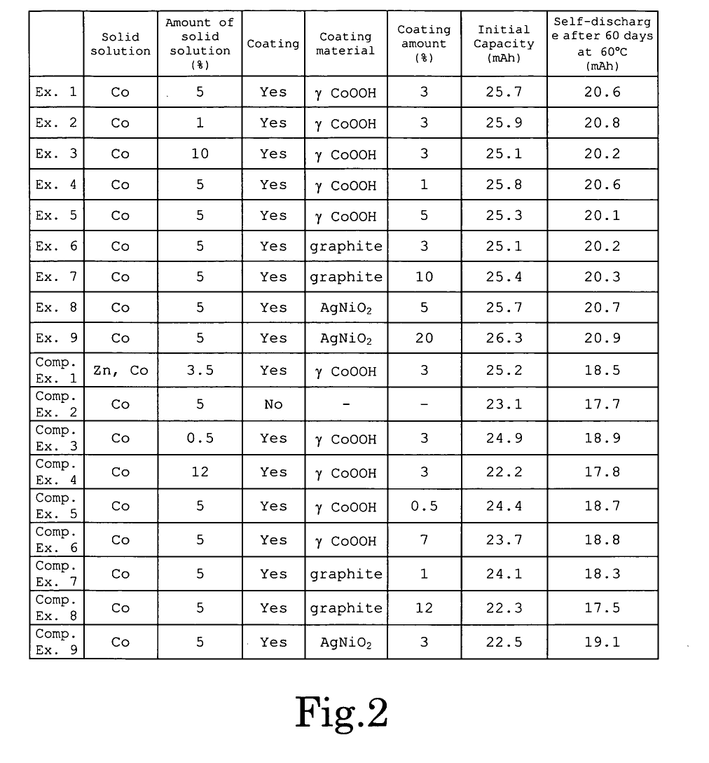

Specifically, 20 samples of each of the batteries were discharged at a constant resistance of 30 kΩ with an end voltage of 1.2 V. The discharge capacities [mAh] thus obtained for the respective batteries are shown in Table of FIG. 2.

Next, 20 samples of each of the batteries were stored for 60 days under an environment at a temperature of 60° C. and dry humidity, then discharged at a constant resistance of 30 kΩ with an end voltage of 1.2 V. The discharge capacities [mAh] thus obtained for the respective batteries are also shown in the table of FIG. 2.

(1) First, Examples 1 to 3 are compared with Comparative Example 1. From the comparison, it is seen that a battery that is excellent in capacity retention capability can be obtained by using cobalt, without using zinc, as a solid solution to be dissolved in the nickel oxyhydroxide. This is because, by allowing only cobalt to be dissolved in the nickel oxyhydroxide in the form of solid solution, the decomposition of the nickel oxyhydroxide resulting from storage can be inhibited because of the structure reinforcing effect of cobalt. More specifically, the coating with a conductive material and the solid dissolution of cobalt in the nickel oxyhydroxide make it possible to provide a battery that is more excellent in capacity and capacity retention capability. Although it is said that the solid dissolution of zinc in the nickel oxyhydroxide has the effect of enlarging the particle size of the nickel oxyhydroxide itself and the effect of inhibiting the volumetric expansion associated with discharge, it is believed that it has an adverse effect on the thermal decomposition inhibiting effect of the nickel oxyhydroxide.

(2) Next, Examples 1 to 9 are compared with Comparative Example 2. From the comparison, it is seen that a battery that is excellent in capacity and capacity retention capability can be obtained by coating the surface of the nickel oxyhydroxide with a substance that has electrical conductivity. This is because coating the surface of the nickel oxyhydroxide with a substance that has electrical conductivity, such as γ cobalt oxyhydroxide, graphite, or a silver-nickel composite oxide, makes it possible to prevent the electrical conductivity degradation of the positive electrode pellets, which results from the formation of nickel hydroxide, which has extremely low electrical conductivity, the absorption of the electrolyte solution, and the volumetric expansion associated with the discharge.

(3) Next, Examples 2 and 3 are compared with Comparative Examples 5 and 6. From the comparison, it is seen that a battery that is excellent in capacity and capacity retention capability can be obtained by setting the amount of solid solution of the cobalt in the nickel oxyhydroxide to be from 1% to 10% with respect to the mass of the nickel oxyhydroxide. This is because, if the amount of solid solution of cobalt in the nickel oxyhydroxide is lower than 1 mass %, the effect of inhibiting the decomposition of the nickel oxyhydroxide originating from storage becomes insufficient as described above, so it becomes impossible to obtain a battery that is excellent in capacity retention capability. On the other hand, if the amount of solid solution of cobalt in the nickel oxyhydroxide is higher than 10 mass %, the electric capacity of the nickel oxyhydroxide reduces correspondingly.

(4) Next, Examples 4 and 5 are compared with Comparative Examples 3 and 4. From the comparison, it is seen that a battery that is excellent in capacity and capacity retention capability can be obtained by setting the coating amount of the γ cobalt oxyhydroxide to the nickel oxyhydroxide to be from 1 mass % to 5 mass % with respect to the mass of the nickel oxyhydroxide. This is because, if the mass ratio of the γ cobalt oxyhydroxide coated on the nickel oxyhydroxide is lower than the 1 mass %, the degradation in electrical conductivity of the positive electrode pellets, which results from the formation of nickel hydroxide, the absorption of the electrolyte solution, and the volumetric expansion associated with the discharge, cannot be prevented sufficiently. On the other hand, if the mass ratio of the γ cobalt oxyhydroxide is higher than 5 mass %, the electric capacity of the nickel oxyhydroxide reduces correspondingly.

(5) Next, Examples 6 and 7 are compared with Comparative Examples 7 and 8. From the comparison, it is seen that a battery that is excellent in capacity and capacity retention capability can be obtained by setting the coating amount of graphite to the nickel oxyhydroxide to be 3 mass % to 10 mass % with respect to the mass of the nickel oxyhydroxide. This is also because, if the mass ratio of graphite coated on the nickel oxyhydroxide is lower than 3 mass %, the degradation in electrical conductivity of the positive electrode pellets cannot be prevented sufficiently, as described above, and consequently, it becomes impossible to obtain a battery that is excellent in capacity and capacity retention capability. On the other hand, if the mass ratio of graphite coated on the nickel oxyhydroxide is higher than 10 mass %, the electric capacity of the nickel oxyhydroxide reduces correspondingly.

(6) Lastly, Examples 8 and 9 are compared with Comparative Example 9. From the comparison, it is seen that a battery that is excellent in capacity and capacity retention capability can be obtained by setting the coating amount of a silver-nickel composite oxide to the nickel oxyhydroxide to be 5 mass % to 20 mass % with respect to the mass of the nickel oxyhydroxide. This is because, if the mass ratio of the silver-nickel composite oxide coated on the nickel oxyhydroxide is less than 5 mass %, the degradation in electrical conductivity resulting from the volumetric expansion cannot be prevented sufficiently.

Next, the advantageous effects of the present embodiment configured in the above-described manner will be described below.

(1) According to the present embodiment, the flat-type alkaline primary battery 1 has a negative electrode active material comprising zinc or zinc alloy powder, and a positive electrode active material in which the surface of nickel oxyhydroxide containing cobalt in the form of solid solution is coated with a conductive material. This can prevent the degradation in electrical conductivity of the battery, which results from the nickel hydroxide formed by the discharge reaction. Moreover, the coating layer covering the particle of the nickel oxyhydroxide can inhibit the volumetric expansion thereof, which results from the formation of nickel hydroxide and the absorption of the electrolyte solution. This serves to inhibit a decrease in the proportion of the conductive agent and prevent the degradation in electrical conductivity of the battery. Therefore, the battery capacity can be improved. Furthermore, since the volumetric expansion due to self-discharge can be prevented by the coating layer, a battery that is excellent in capacity retention capability can be obtained. Thus, the flat-type alkaline primary battery 1 can be used for a long time in such an apparatus as an electronic wristwatch in which the end voltage is set relatively high according to the battery voltage of a silver oxide battery. In addition, the flat-type alkaline primary battery 1 having a high battery voltage can be fabricated at a low cost using nickel oxyhydroxide, which has a nobler potential than that of manganese dioxide or silver oxide.

(2) According to this embodiment, the coating amount of the γ cobalt oxyhydroxide to the nickel oxyhydroxide may be set to be from 1 mass % to 5 mass % with respect to the mass of the nickel oxyhydroxide in the flat-type alkaline primary battery 1. As a result, a battery that is excellent in capacity and capacity retention capability can be obtained.

(3) According to this embodiment, the coating amount of the graphite to the nickel oxyhydroxide may be set to be from 3% to 10% with respect to the mass of the nickel oxyhydroxide in the flat-type alkaline primary battery 1. As a result, a battery that is excellent in capacity and capacity retention capability can be obtained.

(4) According to this embodiment, the coating amount of the silver-nickel composite oxide to the nickel oxyhydroxide may be set to be from 5% to 20% with respect to the mass of the nickel oxyhydroxide in the flat-type alkaline primary battery 1. As a result, a battery that is excellent in capacity and capacity retention capability can be obtained.

(5) According to this embodiment, the amount of solid solution of cobalt in the nickel oxyhydroxide may be set to be from 1% to 10% with respect to the mass of the nickel oxyhydroxide in the flat-type alkaline primary battery 1. As a result, a battery that is excellent in capacity and capacity retention capability can be obtained.

What is claimed is:

1. A flat-type alkaline primary battery comprising:
a positive electrode mixture containing a positive electrode active material comprising solid solution of nickel oxyhydroxide and cobalt;
a negative electrode mixture containing a negative electrode active material comprising zinc or zinc alloy;
a separator for separating the positive electrode mixture and the negative electrode mixture; and
an alkaline electrolyte solution,
wherein a surface of the positive electrode active material is coated with a conductive material.

2. A flat-type alkaline primary battery as set forth in claim 1, wherein the conductive material with which the surface of the positive electrode active material is coated is at least one of γ cobalt oxyhydroxide, graphite, and a silver-nickel composite oxide.

3. A flat-type alkaline primary battery as set forth in claim 2, wherein the coating amount of the γ cobalt oxyhydroxide is from 1 mass % to 10 mass % with respect to the mass of the nickel oxyhydroxide.

4. A flat-type alkaline primary battery as set forth in claim 2, wherein the coating amount of the graphite is from 3 mass % to 10 mass % with respect to the mass of the nickel oxyhydroxide.

5. A flat-type alkaline primary battery as set forth in claim 2, wherein the coating amount of the silver-nickel composite oxide is from 5 mass % to 20 mass % with respect to the nickel oxyhydroxide.

6. A flat-type alkaline primary battery as set forth in claim 1, wherein the amount of cobalt in solid solution is from 1% to 10% with respect to the mass of the nickel oxyhydroxide.
